(19) United States
(12) Patent Application Publication
(10) Pub. No.: US 2026/0303332 A1
(43) Pub. Date: Oct. 1, 2026

(54) APPARATUS FOR ESTABLISHING KEY AGREEMENT BASED ON QUANTUM STATES

(71) Applicant: ELECTRONICS AND TELECOMMUNICATIONS RESEARCH INSTITUTE, Daejeon (KR)

(72) Inventors: Do-Young CHUNG, Daejeon (KR); You-Sung KANG, Daejeon (KR); Jeong-Nyeo KIM, Daejeon (KR); Ju-Young KIM, Daejeon (KR); Young-Kyung LEE, Daejeon (KR)

(73) Assignee: ELECTRONICS AND TELECOMMUNICATIONS RESEARCH INSTITUTE, Daejeon (KR)

(21) Appl. No.: 19/246,116

(22) Filed: Jun. 23, 2025

(30) Foreign Application Priority Data
Mar. 26, 2025 (KR) 10-2025-0038779

(51) Int. Cl. H04L 9/08

(52) U.S. Cl. CPC H04L 9/0852

(57) ABSTRACT

Disclosed herein is an apparatus and method for key agreement based on quantum states. The apparatus divides multiple users into two groups, generates GHZ states modified according to different bases corresponding to the respective groups, shares a secret value with the multiple users using the modified GHZ states, and transmits information for generating a session key to users who request generation of the session key based on the secret value.

### CROSS REFERENCE TO RELATED APPLICATION

This application claims the benefit of Korean Patent Application No. 10-2025-0038779, filed Mar. 26, 2025, which is hereby incorporated by reference in its entirety into this application.

### BACKGROUND OF THE INVENTION

### 1. Technical Field

The present disclosure relates generally to technology for key agreement based on quantum states, and more particularly to technology for key agreement using quantum properties of a specific quantum state.

### 2. Description of the Related Art

As technology for key agreement using quantum properties, there are protocols such as BB84, E91 (or Ekert91), and the like. These protocols are protocols for P2P key agreement and have the following limitations in comparison to the method to be proposed.

First, because these protocols are P2P protocols, key agreement among N users using these protocols requires O(N²), so relatively expensive quantum communication is required.

Also, protocols such as BB84 or E91 perform only a one-time secret agreement, similar to One-Time Pad (OTP), and repeated use thereof requires an additional security technique.

Meanwhile, Korean Patent No. 10-1960426, titled “Apparatus and method for quantum key distribution for multiple users”, discloses an apparatus and method for generating a transmission qubit pair based on a key bit sequence, transmitting the same to a quantum client device, and measuring the transmission qubit pair, thereby verifying the security of a quantum channel.

### SUMMARY OF THE INVENTION

An object of the present disclosure is to use quantum properties to detect whether eavesdropping occurs when sharing a secret, which is essential for key agreement, and to perform digital communication required for key agreement between users.

Another object of the present disclosure is to utilize a secret that is shared using quantum properties, thereby securely generating (updating) a key between users through digital communication without leaking the secret.

A further object of the present disclosure is to reduce quantum communication cost in a process for key agreement between users while providing stability comparable to existing quantum key distribution protocols.

In order to accomplish the above objects, an apparatus for key agreement based on quantum states according to an embodiment of the present disclosure includes one or more processors and memory for storing at least one program executed by the one or more processors, and the at least one program divides multiple users into two groups, generates GHZ states modified according to different bases corresponding to the respective groups, shares a secret value with the multiple users using the modified GHZ states, and transmits information for generating a session key to users who request generation of the session key, based on the secret value.

Here, the at least one program may transmit a GHZ state modified according to a Z-basis and a GHZ state modified according to an X-basis to a first group and a second group, respectively.

Here, the at least one program may request a measurement value from users randomly selected from the two groups, check a state into which the modified GHZ state collapses in each of the two groups based on the measurement value, and check a qubit value received by remaining users, excluding the selected users.

Here, the at least one program may maintain the basis when the qubit value received by the remaining users is |0 [symbol] , but may change the basis when the qubit value is |1 [symbol] .

Here, the at least one program may generate a random bit string composed of a predetermined number of bits, corresponding to the secret value, and share the random bit string with the users.

Here, the at least one program may generate a bit table in which a bit string corresponding to each of the users is recorded.

Here, the at least one program may receive a length of the session key from the users who request generation of the session key and generate a bit string corresponding to the length of the session key.

Here, the information for generating the session key may correspond to an index in the bit table that corresponds to the location of the bit string.

Here, the session key may be generated using a bit string that is retrieved from the bit table using the index received by the users.

Here, the index may correspond to a bit constituting the session key.

Also, in order to accomplish the above objects, a method for key agreement based on quantum states, performed by an apparatus for key agreement based on quantum states, according to an embodiment of the present disclosure includes dividing multiple users into two groups, generating GHZ states modified according to different bases corresponding to the respective groups, sharing a secret value with the multiple users using the modified GHZ states, and transmitting information for generating a session key to users who request generation of the session key, based on the secret value.

Here, generating the modified GHZ states may comprise transmitting a GHZ state modified according to a Z-basis and a GHZ state modified according to an X-basis to a first group and a second group, respectively.

Here, sharing the secret value may include requesting a measurement value from users randomly selected from the two groups, checking a state into which the modified GHZ state collapses in each of the two groups based on the measurement value, and checking a qubit value received by remaining users, excluding the selected users.

Here, sharing the secret value may comprise maintaining the basis when the qubit value received by the remaining users is |0 [symbol] , and changing the basis when the qubit value is |1 [symbol] .

Here, sharing the secret value may comprise generating a random bit string composed of a predetermined number of bits, corresponding to the secret value, and sharing the random bit string with the users.

Here, sharing the secret value may comprise generating a bit table in which a bit string corresponding to each of the users is recorded.

Here, transmitting the information for generating the session key may comprise receiving a length of the session key from the users who request generation of the session key and generating a bit string corresponding to the length of the session key.

Here, the information for generating the session key may correspond to an index in the bit table that corresponds to the location of the bit string.

Here, the session key may be generated using a bit string that is retrieved from the bit table using the index received by the users.

Here, the index may correspond to a bit constituting the session key.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for key agreement based on quantum states according to an embodiment of the present disclosure;

FIG. 2 is a view illustrating a circuit for generating a GHZ state according to an embodiment of the present disclosure;

FIG. 3 is a view illustrating a circuit for generating a modified GHZ state according to an embodiment of the present disclosure; and

FIG. 4 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are provided to fully describe the present disclosure to a person having ordinary knowledge in the art to which the present disclosure pertains. Accordingly, the shapes, sizes, etc. of components in the drawings may be exaggerated in order to make the description clearer.

Throughout the specification, when a part “includes” a component, which means that it may further include other components, rather than excluding other components, unless otherwise specified.

Because the present disclosure may be variously changed and may have various embodiments, specific embodiments will be described in detail below with reference to the attached drawings.

However, it should be understood that those embodiments are not intended to limit the present disclosure to specific disclosure forms and that they include all changes, equivalents or modifications included in the spirit and scope of the present disclosure.

Various terms, such as “first”, “second”, “A”, “B”, “(a)”, “(b)”, etc., can be used to differentiate one component from the other, but the substances, order or sequence of the components are not limited by the terms.

Unless defined differently, all terms used here, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present disclosure, it will be understood that when a component is referred to as being “connected” or “coupled” to another component, it can be directly connected or coupled to the other component, or intervening components may be present.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, components, or combinations thereof, but do not preclude the presence or addition of one or more other features, integers, steps, operations, components, or combinations thereof.

Hereinafter, preferred embodiments of the present disclosure will be described in detail with reference to the accompanying drawings. In the following description of the present disclosure, independent reference numerals are used for components that may be the same in the drawings, in order to facilitate an overall understanding.

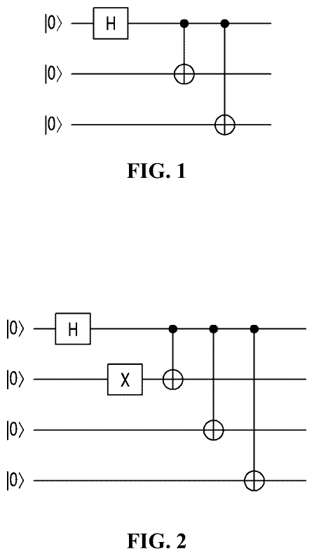

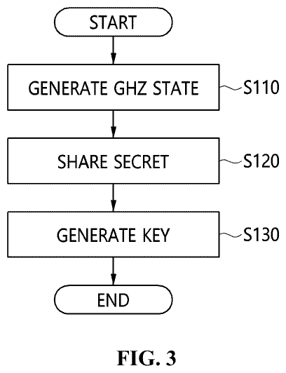

FIG. 1 is a flowchart illustrating a method for key agreement based on quantum states according to an embodiment of the present disclosure. FIG. 2 is a view illustrating a circuit for generating a GHZ state according to an embodiment of the present disclosure. FIG. 3 is a view illustrating a circuit for generating a modified GHZ state according to an embodiment of the present disclosure.

Referring to FIG. 1, in the method for key agreement based on quantum states according to an embodiment of the present disclosure, first, a GHZ state may be generated at step S110.

That is, at step S110, a Key Management System (KMS) may divide multiple users to receive a secret into two groups and generate GHZ states modified according to different bases corresponding to the respective groups.

The KMS may correspond to an apparatus for key agreement based on quantum states according to an embodiment of the present disclosure.

The Greenberger-Horne-Zeilinger (GHZ) state refers to a special state in which multiple quantum particles are entangled to each other, and a measurement-based independent protocol is a method for generating a cryptographic key in such a way that multiple users combine their respective measurement results. Accordingly, multiple users may simultaneously generate a security key.

Referring to FIG. 2, it can be seen that a quantum circuit for generating a GHZ state is illustrated. The GHZ state is a state in which multiple qubits are entangled to each other, and it is basically expressed as

$$\frac{\vert 00 … 0 〉 + \vert 11 … 1 〉}{\sqrt{2}}$$

By applying an X-Gate to such a GHZ state, a specific qubit may be placed into a desired state

$$( e . g . , \text{} in the case of a GHZ state composed of four qubits , \frac{\vert 0100 〉 + \vert 1011 〉}{\sqrt{2}} ) .$$

In the present disclosure, such a state is referred to as a ‘modified GHZ state’.

Referring to FIG. 3, it can be seen that a quantum circuit for generating

$$\frac{\vert 0100 〉 + \vert 1011 〉}{\sqrt{2}}$$

as an example of a modified GHZ state is illustrated.

When measured in the correct basis, a GHZ state collapses into one of two states. For example,

$$\frac{\vert 0100 〉 + \vert 1011 〉}{\sqrt{2}}$$

collapses into either |0100 [symbol] or |1011 [symbol] . In other words, when each of the first and third qubits is measured as |0 [symbol] , the measurement result is |0100 [symbol] , so the second and fourth qubit are |1 [symbol] and |0 [symbol] , respectively. Conversely, when each of the first and third qubits is measured as |1 [symbol] , the measurement result is |1011 [symbol] , so the second and fourth qubits are |0 [symbol] and |1 [symbol] , respectively.

Here, at step S110, a GHZ state modified according to the Z-basis and a GHZ state modified according to the X-basis may be transmitted to a first group and a second group, respectively.

For example, at step S110, when users 1, 2, and 4 belong to Group_Z and users 3, 5, and 6 belong to Group_X, the modified GHZ state generated according to the Z-basis may be transmitted to users 1, 2, and 4 and the modified GHZ state generated according to the X-basis may be transmitted to users 3, 5, and 6.

Here, the modified GHZ state (which user receives |0 [symbol] or |1 [symbol] ) may be randomly generated as a secret value to be shared between the KMS and the user.

Also, in the method for key agreement based on quantum states according to an embodiment of the present disclosure, the secret value may be shared at step S120.

That is, at step S120, using the modified GHZ state, the secret value may be shared with multiple users.

Here, at step S120, the KMS may randomly select K users from each of the two groups (Group_Z and Group_X) and request a measurement value from the users.

Here, at step S120, the KMS identifies the state into which the modified GHZ state collapses in the two groups based on the K measurement values received from the users, thereby identifying the qubit value received by the remaining users ((N/2−K) users in each group), excluding the selected users.

Here, at step S120, the KMS may maintain the basis when the qubit value received by each user is |0 [symbol] , but may change the basis (Z-basis->X-basis or X-basis->Z-basis) when the qubit value is |1 [symbol] .

Here, at step S120, the group to which each user will belong in the subsequent transmission/reception process may be determined based on the changed basis.

Here, at step S120, the KMS may share the basis of the initial bit with the users through BB84 or digital communication.

Here, at step S120, a random bit string composed of a predetermined number of bits, which corresponds to the secret value, may be generated and shared with the users.

Here, at step S120, a bit table in which a bit string corresponding to each of the users is recorded may be generated.

Here, at step S120, a transmission/reception process for sharing the basis of the initial bit is performed L times, whereby the KMS and the user may respectively generate an (N,L)-bit table and an L-bit string, corresponding to the secret value.

In the (N,L)-bit table of the KMS, N indicates each user.

That is, at step S120, a random L-bit string is shared between the KMS and each user, and the KMS shares the L-bit strings for all of the multiple users, whereby the (N,L)-bit table in which the L-bit strings are recorded may be generated.

Here, at step S120, whether eavesdropping occurs in the secret-sharing process and which user's communication process is eavesdropped may be inferred.

When measurement is performed in a basis different from the basis corresponding to the modified GHZ state, which disturbs the GHZ state.

For example, when user 1 belongs to a group corresponding to the Z-basis, if an attacker measures the qubit transmitted to user 1 in a different basis (e.g., X-basis), users belong to the corresponding group measure a value different from that expected by the KMS.

The KMS is made aware of this situation when it requests the measurement value from K users in each group, and as a result, the KMS may detect that eavesdropping (or an error) has occurred when the modified GHZ state was transmitted to the corresponding group.

The group and K users are changed for each bit. Accordingly, the KMS may identify the user segment where a problem is continuously caused, and the KMS may recognize that eavesdropping, an attack, or an error targeting a specific user occurs. Subsequently, the KMS transmits a separate qubit to the corresponding user in order to deceive the attacker into believing that the attacker is not identified, while continuing the key agreement process normally with the remaining users.

When the (N,L)-bit table of the KMS and the L-bit string of the user have been generated through the above-described process, a session key may be generated in cooperation with the KMS at step S130 in response to requests from users A and B.

Also, in the method for key agreement based on quantum states according to an embodiment of the present disclosure, a session key may be generated at step S130.

That is, at step S130, an index for generating a session key may be transmitted to users who requested generation of the session key, based on the secret value.

Here, at step S130, the users may generate a session key using the information for key generation, which is received in response to the key generation request.

Here, at step S130, when the length of the session key to be generated is k, the KMS may receive the session key length, k, from the identifiers (ID_A and ID_B) of users A and B who want to generate the session key.

Here, at step S130, the KMS may retrieve the L-bit string corresponding to each of users A and B from the (N,L)-bit table as shown in Table 1.

TABLE 1

| | 1 bit | 2 bit | 3 bit | 4 bit | 5 bit | 6 bit |
|---|---|---|---|---|---|---|
| Player 1 | 1 | 1 | 0 | 0 | 1 | 0 |
| Player 2 | 0 | 1 | 1 | 1 | 0 | 0 |
| Player 3 | 1 | 0 | 1 | 0 | 0 | 1 |

Here, at step S130, the KMS may generate a random bit string with a length of k. The random bit string with the length of k may be a session key between users A and B.

Here, at step S130, the KMS may randomly retrieve the index corresponding to the bit that constitutes the session key from the L-bit string of users A and B.

For example, at step S130, if the third bit of the session key is 1, the KMS may retrieve the location (index) of a bit randomly selected from among the bits whose value is 1 in the L-bit string of users A and B.

Session key agreement between user 1 and user 2 is described below by taking Tables 2 and 3 as examples.

TABLE 2

| 1 bit | 2 bit | 3 bit | 4 bit | 5 bit | 6 bit |
|---|---|---|---|---|---|
| 1 | 1 | 0 | 0 | 1 | 0 |

TABLE 3

| 1 bit | 2 bit | 3 bit | 4 bit | 5 bit | 6 bit |
|---|---|---|---|---|---|
| 0 | 1 | 1 | 1 | 0 | 0 |

For example, at step S130, when the KMS generates 101 as a random bit string, if the indexes corresponding to the random bit string are extracted from user 1, the indexes may be (1, 4, 5). Also, in the case of user 2, the indexes may be (4, 1, 2).

Here, at step S130, the KMS may transmit the retrieved indexes in the L-bit string of users A and B, corresponding to the session key, to users A and B, respectively.

Accordingly, at step S130, users A and B may generate the session key, and even if the attacker eavesdrops on the indexes, the session key is not exposed because the L-bit string is not exposed.

At step S130, when it is intended to regenerate (update) the session key between users A and B, the above-described process is performed again, whereby the key may be regenerated.

Here, the (N,L)-bit table of the KMS and the L-bit string of the users remain secure because they are not exposed, and if L is sufficiently greater than k, security may be ensured even after multiple reuses.

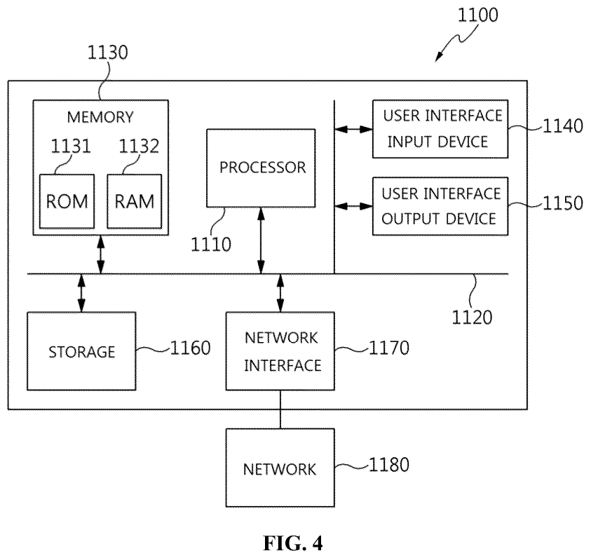

FIG. 4 is a view illustrating a computer system according to an embodiment of the present disclosure.

Referring to FIG. 4, the apparatus for key agreement based on quantum states and quantum devices corresponding to users according to an embodiment of the present disclosure may be implemented in a computer system 1100 including a computer-readable recording medium. As illustrated in FIG. 4, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for key agreement based on quantum states according to an embodiment of the present disclosure includes one or more processors 1110 and memory 1130 for storing at least one program executed by the one or more processors 1110. The at least one program divides multiple users into two groups, generates GHZ states modified according to different bases corresponding to the respective groups, shares a secret value with the multiple users using the modified GHZ states, and transmits information for generating a session key to users who request generation of the session key, based on the secret value.

Here, the at least one program may transmit a GHZ state modified according to a Z-basis and a GHZ state modified according to an X-basis to the first group and the second group, respectively.

Here, the at least one program may request a measurement value from users randomly selected from the two groups, check a state into which the modified GHZ state collapses in each of the two groups based on the measurement value, and check a qubit value received by the remaining users, excluding the selected users.

Here, the at least one program may maintain the basis when the qubit value received by the remaining users is |0 [symbol] , but may change the basis when the qubit value is |1 [symbol] .

Here, the at least one program may generate a random bit string composed of a predetermined number of bits, corresponding to the secret value, and share the random bit string with the users.

Here, the at least one program may generate a bit table in which a bit string corresponding to each of the users is recorded.

Here, the at least one program may receive a length of the session key from the users who request generation of the session key and generate a bit string corresponding to the length of the session key.

Here, the information for generating the session key may correspond to an index in the bit table that corresponds to the location of the bit string.

Here, the session key may be generated using a bit string that is retrieved from the bit table using the index received by the users.

Here, the index may correspond to a bit constituting the session key.

The present disclosure may detect whether eavesdropping occurs by utilizing quantum properties when sharing a secret, which is essential for key agreement, and may perform digital communication required for key agreement between users.

Also, the present disclosure may utilize a secret that is shared using quantum properties, thereby securely generating (updating) a key between users through digital communication without leaking the secret.

Also, the present disclosure may reduce quantum communication cost in a process for key agreement between users while providing stability comparable to existing quantum key distribution protocols.

As described above, the apparatus and method for key agreement based on quantum states according to the present disclosure are not limitedly applied to the configurations and operations of the above-described embodiments, but all or some of the embodiments may be selectively combined and configured, so the embodiments may be modified in various ways.

What is claimed is:

1. An apparatus for key agreement based on quantum states, comprising:
one or more processors; and
memory for storing at least one program executed by the one or more processors,
wherein the at least one program
divides multiple users into two groups,
generates GHZ states modified according to different bases corresponding to the respective groups,
shares a secret value with the multiple users using the modified GHZ states, and
transmits information for generating a session key to users who request generation of the session key, based on the secret value.

2. The apparatus of claim 1, wherein the at least one program transmits a GHZ state modified according to a Z-basis and a GHZ state modified according to an X-basis to a first group and a second group, respectively.

3. The apparatus of claim 1, wherein the at least one program requests a measurement value from users randomly selected from the two groups, checks a state into which the modified GHZ state collapses in each of the two groups based on the measurement value, and checks a qubit value received by remaining users, excluding the selected users.

4. The apparatus of claim 3, wherein the at least one program maintains the basis when the qubit value received by the remaining users is |0 [symbol] , but changes the basis when the qubit value is |1 [symbol] .

5. The apparatus of claim 1, wherein the at least one program generates a random bit string composed of a predetermined number of bits, corresponding to the secret value, and shares the random bit string with the users.

6. The apparatus of claim 5, wherein the at least one program generates a bit table in which a bit string corresponding to each of the users is recorded.

7. The apparatus of claim 6, wherein the at least one program receives a length of the session key from the users who request generation of the session key and generates a bit string corresponding to the length of the session key.

8. The apparatus of claim 7, wherein the information for generating the session key corresponds to an index in the bit table that corresponds to a location of the bit string.

9. The apparatus of claim 8, wherein the session key is generated using a bit string that is retrieved from the bit table using the index received by the users.

10. The apparatus of claim 9, wherein the index corresponds to a bit constituting the session key.

11. A method for key agreement based on quantum states, performed by an apparatus for key agreement based on quantum states, comprising:
dividing multiple users into two groups and generating GHZ states modified according to different bases corresponding to the respective groups;
sharing a secret value with the multiple users using the modified GHZ states; and
transmitting information for generating a session key to users who request generation of the session key, based on the secret value.

12. The method of claim 11, wherein generating the modified GHZ states comprises transmitting a GHZ state modified according to a Z-basis and a GHZ state modified according to an X-basis to a first group and a second group, respectively.

13. The method of claim 11, wherein sharing the secret value comprises
requesting a measurement value from users randomly selected from the two groups,
checking a state into which the modified GHZ state collapses in each of the two groups based on the measurement value, and
checking a qubit value received by remaining users, excluding the selected users.

14. The method of claim 13, wherein sharing the secret value comprises maintaining the basis when the qubit value received by the remaining users is |0 [symbol] , and changing the basis when the qubit value is |1 [symbol] .

15. The method of claim 11, wherein sharing the secret value comprises generating a random bit string composed of a predetermined number of bits, corresponding to the secret value, and sharing the random bit string with the users.

16. The method of claim 15, wherein sharing the secret value comprises generating a bit table in which a bit string corresponding to each of the users is recorded.

17. The method of claim 16, wherein transmitting the information for generating the session key comprises receiving a length of the session key from the users who request generation of the session key and generating a bit string corresponding to the length of the session key.

18. The method of claim 17, wherein the information for generating the session key corresponds to an index in the bit table that corresponds to a location of the bit string.

19. The method of claim 18, wherein the session key is generated using a bit string that is retrieved from the bit table using the index received by the users.

20. The apparatus of claim 19, wherein the index corresponds to a bit constituting the session key.
